(19) United States
(12) Patent Application Publication
(10) Pub. No.: US 2005/0089036 A1
(43) Pub. Date: Apr. 28, 2005

(54) System for multicasting multimedia contents

(75) Inventors: Hak-goo Lee, Suwon-si (KR); Sun-woo Kim, Suwon-si (KR); Sang-hyun Shin, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/930,911

(22) Filed: Sep. 1, 2004

(30) Foreign Application Priority Data
Sep. 6, 2003 (KR) 2003-62373

(51) Int. Cl. H04L 12/56

(52) U.S. Cl. 370/390; 370/432

(57) ABSTRACT

A system for multicasting multimedia contents using Multicast Listener Discovery protocols according IPv6 standards and a method of reproducing multimedia contents using the same. The method of reproducing multimedia contents includes transmitting a first packet including channel information regarding a channel selected by a user, receiving a second packet including multimedia contents transmitted by multicasting through the selected channel in response to the first packet, and reproducing the multimedia contents included in the received second packet. Multicast packets transmitted to a router in a connection network by multicasting can be transmitted to home multimedia devices, so that congestion of the Internet in the IPv6 environment by an increased amount of data can be prevented.

### CROSS-REFERENCE TO RELATED APPLICATION

This application claims the benefit of Korean Patent Application No. 2003-62373, filed on Sep. 6, 2003, in the Korean Intellectual Property Office, the disclosure of which is incorporated herein by reference.

### BACKGROUND OF THE INVENTION

1. Field of the Invention

The present invention relates to a system for multicasting multimedia contents using an IPv6 Multicast Listener Discovery (MLD).

2. Description of the Related Art

A wideband access networks being implemented around the world. The wideband access network is a public line that provides a wider bandwidth and is much less expensive than private line such as T1, E1,etc. For example, the bandwidth may be provided using a digital subscriber line (DSL) or a cable modem. An IPv6 environment has a wider IPv6 address space than an IPv4 environment. Thus, IPv6 addresses can be allocated to all types of appliances, such televisions (TVs), refrigerators, and so forth, etc. Users do not need to directly input the corresponding IPv6 addresses using an address auto configuration function.

In the wideband access network and the IPv6 environment, almost all household electric appliances will be assigned IPv6 addresses to be connected to the Internet, and contents providers will provide each of the worldwide household electric appliances with contents. However, if the contents providers provide the household electric appliances with contents on a one-to-one basis, the Internet will be congested with a mass of data. In particular, as the access network becomes wideband, the multimedia contents providers will provide multimedia contents requiring a wide bandwidth for each of household electric appliances of a multimedia device via the Internet. Consequently, the Internet will be more seriously congested with data.

### SUMMARY OF THE INVENTION

The invention provides an apparatus and method that enable all types of household multimedia devices to reproduce multimedia contents using a limited network bandwidth in an IPv6 environment, which requires a wide bandwidth to transmit multimedia contents over the Internet as a connection network becomes wider.

According to an aspect of the invention, there is provided a method of reproducing multimedia contents, including: transmitting a first packet including channel information regarding a channel selected by a user; receiving a second packet including multimedia contents transmitted by multicasting through the selected channel in response to the first packet; and reproducing the multimedia contents included in the received second packet.

According to another aspect of the invention, there is provided a home network relaying method including: receiving a first packet including channel information regarding a channel selected by a user of a multimedia device; transmitting a second packet including a multicast address corresponding to the channel information included in the received first packet; and receiving a third packet including multimedia contents transmitted through the selected channel by using the multicast address in response to the second packet.

According to another aspect of the invention, there is provided a home gateway routing method including: receiving a first packet including a multicast address of a channel selected by a user from a home gateway; receiving a second packet including multimedia contents transmitted through the selected channel by multicasting using the multicast address included in the received first packet as a destination address; and transmitting a third packet including the multimedia contents included in the received second packet to the home gateway.

According to another aspect of the invention, there is provided a computer readable medium having embodied thereon a computer program for the above-described method of reproducing multimedia contents.

According to another aspect of the invention, there is provided a computer readable medium having embodied thereon a computer program for the above-described home network relaying method.

According to another aspect of the invention, there is provided a computer readable medium having embodied thereon a computer program for the above-described home gateway routing method.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the configuration of a system for multicasting multimedia contents according to an embodiment of the invention;

FIG. 2 illustrates a protocol stack of the system of FIG. 1;

FIG. 3 is a block diagram of a multimedia device, a home gateway, and a router of FIG. 1;

FIG. 4 illustrates a format of a multimedia device address and channel information stored in a multimedia device address and channel information storage device of FIG. 3;

FIG. 5 illustrates a format of channel information and multicast addresses stored in a channel information and multicast address storage device of FIG. 3;

FIG. 6 illustrates a format of multicast addresses of channels and an address of a home gateway stored in a home gateway address and multicast address storage device of FIG. 3;

FIG. 7 is a flowchart of a method of reproducing multimedia contents according to an embodiment of the invention;

FIG. 8 is a flowchart illustrating a method of relaying a home network according to an embodiment of the invention;

FIG. 9 is a flowchart illustrating a method of routing a home gateway according to an embodiment of the invention; and

FIG. 10 is a flowchart illustrating a method of multicasting multimedia contents according to an aspect of the invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

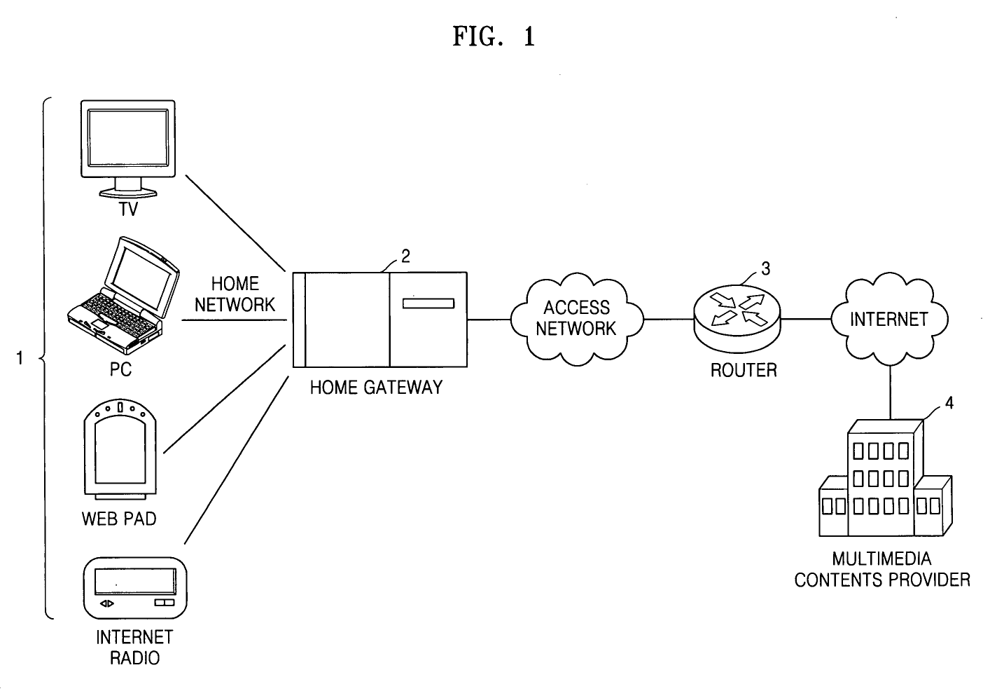

FIG. 1 is a view illustrating the configuration of a system for multicasting multimedia contents according to an aspect of the invention. Referring to FIG. 1, the system includes a multimedia device 1, a home gateway 2, and a router 3.

The multimedia device 1 includes various devices that are installed in a user environment, such as a television (TV) 16, a personal computer (PC) 17, a web pad 18, and an Internet radio 19. The devices, are connected to the home gateway 2 via the home network, such as Ethernet, a wireless local area network (LAN), phone line networking alliance (PNA), power line communication (PLC), Bluethooth, or the like. The home gateway 2 is connected to the router 3 via an access network.

The access network is a small-scale communication network that is connected to a wide area network (WAN), such as the Internet or the like. The multimedia device 1 transmits channel information to the home gateway 2 using a protocol that will be discussed later, and the home gateway 2 transmits a multicast address to the router 3 using an IPv6 MLD protocol.

The multimedia device 1 receives the channel information from a user and transmits to the home gateway 2 a channel information packet that includes a source address field in which an address of the multimedia device 1 is recorded, a destination address field in which an address of the home gateway 2 is recorded, and a channel information field in which the channel information is recorded. The user selects the channel using a controller or the like. Also, the channel information related to the selected channel is included in the channel information packet and transmitted to the home gateway 2. According to the IPv6 packet format, source and destination addresses are recorded in source and destination address fields of a header, respectively, and user data such as channel information is recorded in a channel information field of a payload. The payload refers to a part in which substantial data to be transmitted is recorded. A predetermined area of the payload in which channel information is recorded is defined as a channel information field.

The home gateway 2 receives the channel information packet from the multimedia device 1 and then transmits to the router 3 an MLD report message packet including a source address field in which an address of the home gateway 2 is recorded, a destination address field in which an address of the router 3 is recorded, and a multicast address field in which a multicast address of the channel indicated by the channel information in the channel information field of the channel information packet is recorded. Multimedia contents are transmitted to the multimedia devices, i.e., to the TV 16, the PC 17, the web pad 18, and the Internet radio 19, using the IPv6 MLD protocol so as to efficiently use a limited bandwidth. In order to use the IPv6 MLD protocol, the home gateway 2, which manages the multimedia device 1 that is to receive the multimedia contents, transmits an MLD report message to the router 3 via the access network.

The MLD report message is reported to the router 3 to join a multicast address. Thus, the MLD report message carries the multicast address to be joined. Each multicast address is allocated to each channel, and thus the MLD report message carrying the multicast address to be joined indicates that the MLD report message carries the channel information concerning the channel selected by the user. The MLD report message is a type of IPv6 Internet Control Message Protocol (ICMP) message. The MLD report message packet is an IPv6 packet having an MLD report message attached thereto.

The router 3 receives the MLD report message packet from the home gateway 2 and then a multicast packet, including a source address field in which an address of a multimedia contents provider 4 is recorded, a destination address field in which the multicast address in the multicast address field of the MLD report message packet is recorded, and a multimedia contents field in which multimedia contents provided through the channel indicated by the channel information are recorded, from the multimedia contents provider 4 that is to provide the multimedia contents. When the router 3 receives the MLD report message packet, the router 3 transmits a multicast packet that has a multicast address recorded in the received MLD report message packet as a destination address to the home gateway 2 from which the MLD report message has transmitted. As described above, a multicast address of an MLD report message packet corresponds to a channel. Thus, the transmission of the MLD report message packet from the home gateway 2 to the router 3 indicates the transmission of channel information concerning a channel through which multimedia contents are to be viewed, and the transmission of the multicast packet from the router 3 to the home gateway 2 indicates the transmission of the multimedia contents (for example, film or music) provided through the corresponding channel to the home gateway 2.

The multimedia contents provider 4 transmits the multicast packet to the router 3 via the Internet using a multicasting method. According to the IPv6 multicasting method, when the multimedia contents provider 4 transmits the same multicast packet to a plurality of routers including the router 3 on the same local link, one of the routers receives the multicast packet, makes as many copies of the multicast packet as the routers on the same local link, and transmits the copied multicast packets to the routers on the same local link, respectively. The repetitious multicasting of the multicast packet allows the multicast packet to finally reach the router 3 over the access network. Here, the multicast address is an address necessary for determining a destination of the multicast packet. In other words, the above-mentioned routers have the same multicast address.

In an IPv6 environment, any number of multimedia devices, which have each been assigned IPv6 addresses, may be installed in user environments throughout the world. When a multimedia contents provider provides such multimedia devices with contents via the Internet using a unicasting method, i.e., a one-to-one method, the Internet may be congested with a mass of data and thus may be paralyzed. In the present invention, the above-described multicasting method is used to solve such a problem, and the IPv6 MLD protocol is adopted to realize the multicasting method.

The router 3 also transmits to the home gateway 2 a multicast packet including a source address field in which an address of the router 3 is recorded, a destination address field in which an address of the home gateway 2, a multimedia contents field in which the multimedia contents in the multimedia contents field of the received multicast packet are recorded, and a multicast address field in which the multicast address in the destination address field of the received multicast packet is recorded. The router 3 transmits the received multicast packet including the multicast contents to the home gateway 2 that manages the multimedia device 1 which is to receive the multimedia contents of the received multicast packet.

The home gateway 2 receives the multicast packet from the router 3 and transmits to the multimedia device 1 a multicast packet including a source address field in which an address of the home gateway 2 is recorded, a destination address field in which an address of the multimedia device 1 is recorded, and a multimedia contents field in which the multimedia contents in the multimedia contents field of the received multicast packet are recorded. The home gateway 2 transmits the received multicast packet including the multicast contents to the multimedia device 1 which is to receive the multimedia contents in the received multicast packet.

The multimedia device 1 receives the multicast packet from the home gateway 2 and reproduces the multimedia contents in the multimedia contents field of the received multicast packet.

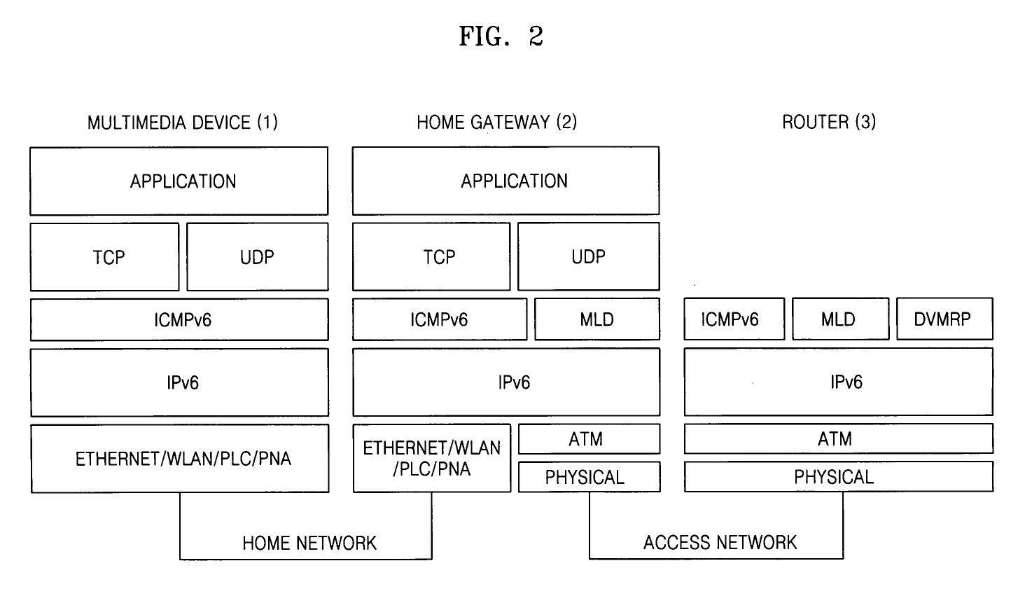

FIG. 2 is a view illustrating a protocol stack of the system of FIG. 1. Referring to FIG. 2, an algorithm of the system of FIG. 1 is divided into a part managed by the multimedia device 1, a part managed by the home gateway 2, and a part managed by the router 3 and then stacked on application layers, respectively. Data generated on the application layer of the multimedia device 1 is transmitted in the form of an IP packet to the home gateway 2 via a transport layer using a Transmission Control Protocol and/or User Datagram Protocol (TCP/UDP), a network layer using IPv6 and ICMPv6, and a physical layer using the Ethernet, wireless LAN, PLC, or PNA. The IP packet reaches the application layer of the home gateway 2 in reverse order. However, since the invention adopts the IPv6 MLD protocol, a protocol stack of the home gateway 2 includes an MLD layer. The IP packet transmitted from the home gateway 2 reaches the application layer of the router 3 according to the same method.

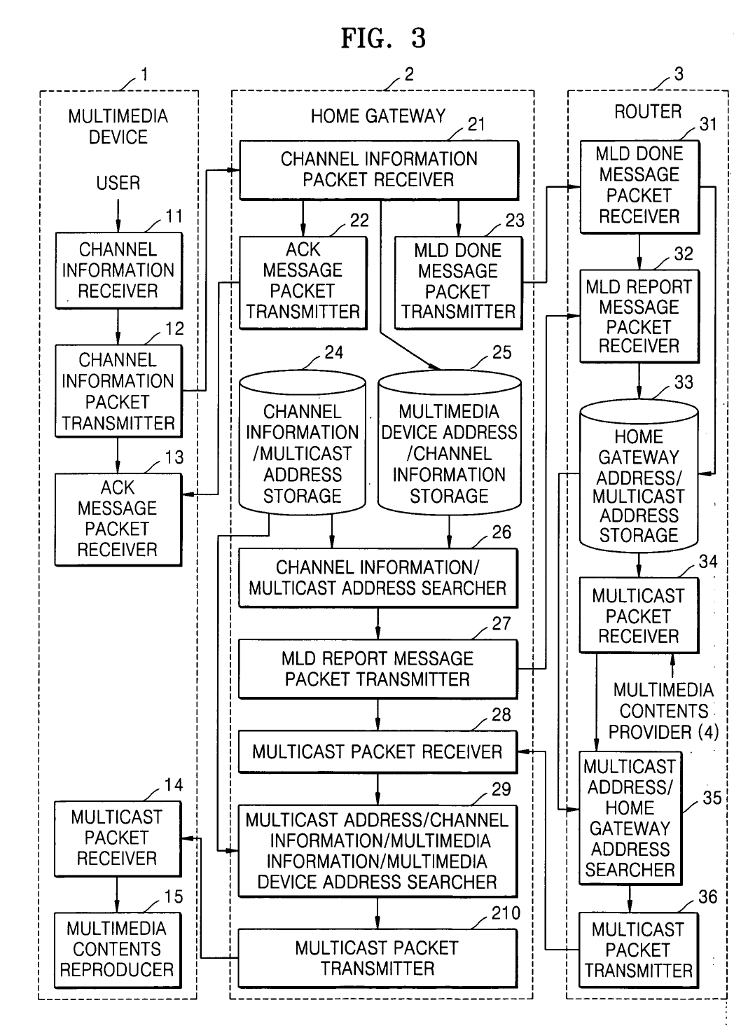

FIG. 3 is a block diagram illustrating the detailed configuration of the multimedia device 1, the home gateway 2, and the router 3 of FIG. 1. Referring to FIG. 3, the multimedia device 1 includes a channel information receiver 11, a channel information packet transmitter 12, an acknowledgement (ACK) message packet receiver 13, a multicast packet receiver 14, and a multimedia contents reproducer 15.

The channel information receiver 11 receives the channel information relating to the channel selected by the user. The channel information packet transmitter 12 transmits the channel information packet, including the source address field in which the address of the multimedia device 1 is recorded, the destination address field in which the address of the home gateway 2 is recorded, and the channel information field in which the channel information is recorded. The channel information packet is recorded in a payload of a UDP and/or IP packet of the protocol stack of FIG. 2. Instead of a highly reliable TCP, the UDP, which has a fast transmission speed and applies less load to the system than the TCP, is used due to the high reliability of the home network.

The ACK message packet receiver 13 receives an ACK message packet including a source address field in which the address of the home gateway 2 is recorded, a destination address field in which the address of the multimedia device 1 is recorded, and an ACK message for acknowledging the successful receipt of the channel information packet, from the home gateway 2, which received the channel information packet from the channel information packet transmitter 12. The channel information packet transmitter 12 periodically transmits the channel information packet until the ACK message packet receiver 13 receives the ACK message packet. When the ACK message packet receiver 13 receives the ACK message packet, the channel information packet transmitter 12 stops transmitting the channel information packet. When the home gateway 2 receives the channel information packet from the channel information packet transmitter 12, the home gateway 2 transmits the ACK message packet including the ACK message for acknowledging the successful reception of the channel information packet. Thus, the multimedia device 1 secures the reliability of the transmission of the channel information packet by periodically transmitting the channel information packet until the multimedia device 1 receives the ACK message.

The multicast packet receiver 14 receives the multicast packet including the source address filed in which the address of the home gateway 2 is recorded, the destination address field in which the address of the multimedia device 1 is recorded, and the multimedia contents field in which the multimedia contents provided through the channel indicated by the channel information are recorded, from the home gateway 2, which received the channel information packet from the channel information packet transmitter 12. The multimedia contents reproducer 15 reproduces the multimedia contents in the multimedia contents field of the multicast packet. When the channel information is transmitted to the home gateway 2 as described above, the home gateway 2 transforms the channel information into a multicast address and transmits the multicast address to the multimedia contents provider 4, which is to provide a multicast packet. The multimedia contents provider 4 transmits multimedia contents corresponding to the received multicast address to the router 3. Thereafter, the multimedia contents reach the multimedia device 1 via the home gateway 2. Here, various kinds of data to be transmitted may be included in an IPv6 packet and then transmitted.

As shown in FIG. 3, the home gateway 2 includes a channel information packet receiver 21, an ACK message packet transmitter 22, an MLD done message packet transmitter 23, a channel information and multicast address storage 24, a multimedia device address and channel information storage 25, a channel information and multicast address searcher 26, an MLD report message packet transmitter 27, a multicast packet receiver 28, a multicast address, channel information, and multimedia device address searcher 29, and a multicast packet transmitter 210.

The channel information packet receiver 21 receives from the multimedia device 1 the channel information packet including the source address field in which the address of the multimedia device 1 is recorded, the destination address field in which the address of the home gateway 2 is recorded, and the channel information field in which the channel information concerning the channel selected by the user is recorded. When the channel information packet receiver 21 receives the channel information packet, the ACK message packet transmitter 22 transmits the ACK message packet including the source address field in which the address of the home gateway 2 is recorded, the destination address field in which the address of the multimedia device 1 is recorded, and the ACK message for acknowledging the successful reception of the channel information packet.

When the channel information packet receiver 21 receives the channel information packet, the MLD done message packet transmitter 23 transmits to the router 3 an MLD done message packet including a source address field in which the address of the home gateway 2 is recorded, a destination address field in which the address of the router 3 is recorded, and an MLD done message for soliciting for stopping transmitting the multicast packet when the channel information packet receiver 21 receives the channel information. However, when the MLD done message packet transmitter 23 does not transmit the MLD done message to the router 3, the router 3 continues to transmit multimedia contents provided through a channel right before a channel change is performed, to the multimedia device 1 and the multimedia device 1 receives multimedia contents through several channels at the same time. However, unlike a device, such as a TV, the radio, or the like, through which only contents provided through one channel are viewed, a PC can simultaneously display contents provided through several channels. In this case, the MLD done message packet transmitter 21 does not transmit the MLD done message packet to the router 3.

The multimedia device address and channel information storage 25 stores the address of the multimedia device 1 in the source address field of the channel information packet and the channel information in the channel information field of the channel information packet so as to correspond with each other. The multimedia device address and channel information storage 25 stores the address of the multimedia device 1 and channel information concerning a channel of the multimedia device 1 through which the user desires to view multimedia contents, so as to correspond to each other on a one-to-one basis.

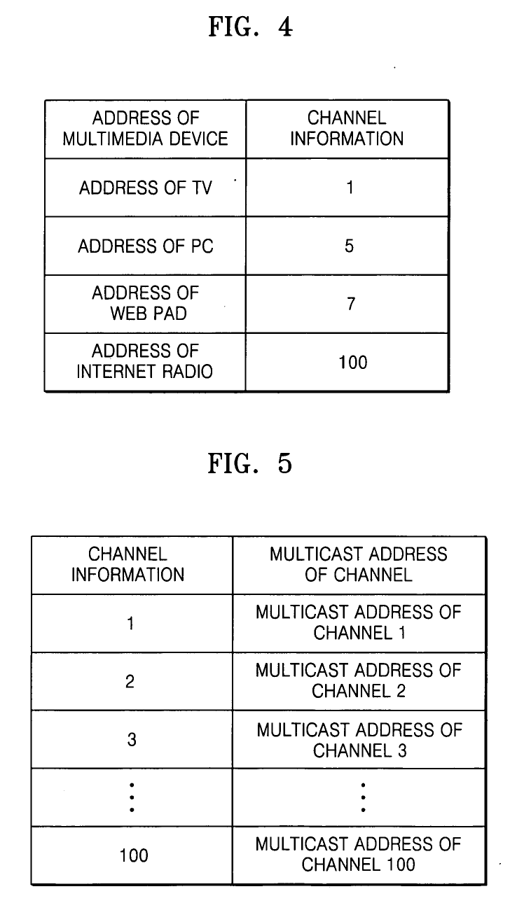

FIG. 4 illustrates a format of the address of the multimedia device 1 and the channel information stored in the multimedia device address and channel information storage 25. Referring to FIG. 4, for an easy search of inter-corresponding information, the multimedia device address and channel information storage 25 stores the address of the multimedia device 1 and the channel information in a table format. For example, an address of the TV 16 corresponds to channel 1, an address of the PC 17 corresponds to channel 5, an address of the web pad 18 corresponds to channel 7, and an address of the Internet radio 19 corresponds to channel 100. Thus, the user can view the TV 16 through the channel 1, uses the PC 17 through the channel 5, uses the web pad 18 through the channel 7, and listens to the Internet radio through the channel 100.

The channel information and multicast address storage 24 stores channel information on all of channels and multicast addresses of the channels indicated by the channel information, so that the channels and the multicast addresses correspond to each other, respectively. The IPv6 MLD protocol uses a multicast address as a sign for receiving a multicast packet. Thus, the multicast address, not the channel information, must be used to efficiently receive multimedia contents within a limited bandwidth using MLD. Since the channel information and multicast address storage 24 stores the channel information on all of the channels and the multicast addresses corresponding to the channels, channel information may be transformed into multicast addresses that can be recognized by the router 3 according to the MLD with reference to the channel information and multicast address storage 24.

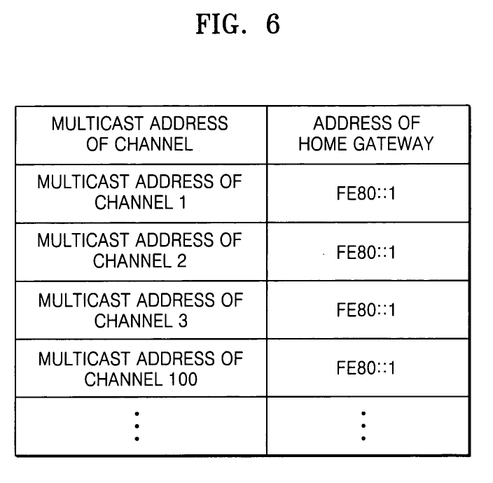

FIG. 5 illustrates a format of the channel information and the multicast addresses stored in the channel information and multicast address storage 24 of FIG. 3. Referring to FIG. 5, for easy search for inter-corresponding information, the channel information and multicast address storage 24 stores channel information and multicast addresses in a table format. The channel information and multicast address storage 24 sequentially stores channel information concerning channels 1 through 100 and multicast addresses of the channel 1 through 100.

The channel information and multicast address searcher 26 searches the channel information and multicast address storage 24 for channel information corresponding to the channel information stored in the multimedia device address and channel information storage 25 and a multicast address corresponding to the searched channel information. For example, with reference to FIGS. 4 and 5, the channel information and multicast address searcher 26 searches the channel information and multicast address storage 24 for channel information concerning channels 1, 5, 7, and 100 corresponding to channel information concerning channels 1, 5, 7, and 100 stored in the multimedia device address and channel information storage 25. Next, the channel information and multicast address searcher 26 searches the channel information and multicast address storage 24 for multicast addresses of the channels 1, 5, 7, and 100.

The MLD report message packet transmitter 27 transmits to the router 3 the MLD report message packet including the source address field in which the address of the home gateway 2 is recorded, the destination address field in which the address of the router 3 is recorded, and the multicast address field in which the searched multicast address is recorded. For example, the MLD report message packet transmitter 27 transmits four MLD report message packets, i.e., MLD report message packets respectively including the multicast addresses of the channels 1, 5, 7, and 100, to the router 3.

The multicast packet receiver 28 receives from the router 3 the multicast packet including the source address field in which the address of the router 3 is recorded, the destination address field in which the address of the home gateway 2 is recorded, the multimedia contents field in which multimedia contents provided through a channel, to which the multicast address in the multicast address field of the MLD report message packet is allocated, is recorded, and the multicast address field in which the multicast address in the multicast address field of the MLD report message packet is recorded. If the multicast packet receiver 28 has not received the multicast packet, the MLD report message packet transmitter 27 periodically transmits the MLD report message packet to the router 3 until the multicast packet receiver 28 receives the multicast packet. If the multicast packet receiver 28 has received the multicast packet, the MLD report message packet transmitter 27 stops transmitting the MLD report message packet to the router 3. This operation secures the reliability of the transmission of the MLD report message packet, which is an initial step of an MLD process.

Information for identifying the multicast packet is required to exactly transmit the multicast packet to the multimedia device 1, which receives the multimedia contents in the multimedia packet and may be a multicast address. In other words, the channel information and multicast address storage 24 and the multimedia device address and channel information storage 25 may be searched for the address of the multimedia device 1 using the multicast address. The multicast address, channel information, and multimedia device address searcher 29 searches the channel information and multicast address storage 24 for a multicast address corresponding to the multicast address in the multicast address field of the multicast packet received from the multicast packet receiver 28 and channel information corresponding to the searched multicast address and then searches the multimedia device address and channel information storage 25 for channel information corresponding to the searched channel information and an address of the multimedia device 1 corresponding to the searched channel information. For example, the multicast address, channel information, and multimedia device address searcher 29 searches the channel information and multicast address storage 24 for multicast addresses of channels 1, 5, 7, and 100 corresponding to the multicast addresses of the channels 1, 5, 7, and 100 in the multicast address fields of the four multicast packets the multicast packet receiver 28 has received and channel information concerning channels 1, 5, 7, and 100 corresponding to the searched multicast addresses and then searches the multimedia device address and channel information storage 25 for channel information concerning channels 1, 5, 7, and 100 corresponding to the searched channel information and addresses of the TV 16, the PC 17, the web pad 18, and the Internet radio 19 corresponding to the searched channel information.

The multicast packet transmitter 210 transmits to the multimedia device 1 the multicast packet including the source address field in which the address of the home gateway 2 is recorded, the destination address field in which the address of the multimedia device 1 searched by the multicast address, channel information, and multimedia device address searcher 29 is recorded, and the multicast contents field in which the multimedia contents in the multimedia contents field of the multicast packet the multicast packet receiver 28 has received are recorded.

Referring to FIG. 3, the router 3 includes an MLD done message packet receiver 31, an MLD report message packet receiver 32, a home gateway address and multicast address storage 33, a multicast packet receiver 34, a multicast address and home gateway address searcher 35, and a multicast packet transmitter 36.

The MLD report message receiver 32 receives from the home gateway 2 the MLD report message packet including the source address field in which the address of the home gateway 2 is recorded, the destination address field in which the address of the router 3 is recorded, and the multicast address field in which the multicast address of the channel indicated by the channel information is recorded.

The home gateway address and multicast address storage 33 stores the address of the home gateway 2 in the source address field of the MLD report message packet and the multicast address in the multicast address field of the MLD report message packet so as to correspond to each other.

FIG. 6 illustrates a format of the address of the home gateway 2 and the multicast addresses stored in the home gateway address and multicast address storage 33 of FIG. 3. Referring to FIG. 6, the home gateway address and multicast address storage 33 stores the address of the home gateway 2 and the multicast addresses in a table format to simplify the search method. For example, the home gateway address and multicast address storage 33 stores multicast addresses of channels 1, 5, 7, and 100 and the address, FE80::1, of the home gateway 2 corresponding to the multicast addresses. The channels 1, 5, 7, and 100 are selected by the user of the multimedia device 1 in the home that is managed by the home gateway 2. Thus, the address, FE80::1, of the home gateway 2 is stored in home gateway address fields corresponding to multicast address fields of the channels 1, 5, 7, and 100. A plurality of home gateways may be connected to the router 3 via the access network, and multicast addresses and addresses of the home gateways transmitted from the home gateways may be stored in the home gateway address and multicast address storage 33. In other words, although not shown, besides the multicast addresses of the channels 1, 5, 7, and 100, multicast addresses of channels transmitted from another home gateway may be stored in the home gateway address and multicast address storage 33, and an address, for example FE80::2, of another home gateway requiring multicast packets transmitted through the channels 1, 5, 7, and 100 may be stored in home gateway address fields corresponding to the multicast address fields of the channels 1, 5, and 7, and 100.

Referring to FIG. 3, the multicast packet receiver 34 receives the multicast packet including the source address field in which the address of the multimedia contents provider 4 is recorded, the destination address field in which the multicast addresses in the home gateway address and multicast address storage 33 are recorded, and the multimedia contents field in which the multimedia contents provided through the channel indicated by the channel information are recorded, from the multimedia contents provider 4 which is to provide the multimedia contents through the channel indicated by the channel information.

The multicast address and home gateway address searcher 35 searches the home gateway address and multicast address storage 33 for a multicast address corresponding to the multicast address in the destination address field of the multicast packet the multicast packet receiver 32 has received and searches the home gateway address and multicast address storage 33 for an address of the home gateway corresponding to the searched multicast address. For example, the multicast address and home gateway address searcher 35 searches the home gateway address and multicast address storage 33 for multicast addresses corresponding to the multicast addresses of the channels 1, 5, 7, and 100 recorded in the destination address fields of the four multicast packets the multicast packet receiver 32 has received and the address, FE80::1, of the home gateway 2 corresponding to the multicast addresses of the channels 1, 5, 7, and 100.

The multicast packet transmitter 36 transmits to the home gateway 2 the multicast packet including the source address field in which the address of the router 3 is recorded, the destination address field in which the address of the home gateway 2 searched by the multicast address and home gateway address searcher 35 is recorded, the multimedia contents field in which the multimedia contents in the multimedia contents field of the multicast packet the multicast packet receiver 34 has received, and the multicast address field in which the multicast address in the destination address field of the multicast packet the multicast packet receiver 34 has received is recorded.

The MLD done message packet receiver 31 receives from the home gateway 2 the MLD done message packet including the source address field in which the address of the home gateway 2 is recorded, the destination address field in which the address of the router 3 is recorded, and the MLD done message for soliciting for stopping transmitting the multicast packet when the channel information packet receiver 32 receives the channel information. Here, the home gateway address and multicast address storage 33 deletes the address of the home gateway 2 in the source address field of the MLD done message packet received by the MLD done message packet receiver 32. Thus, a multicast packet is not transmitted to the home gateway 2 because the address has been deleted.

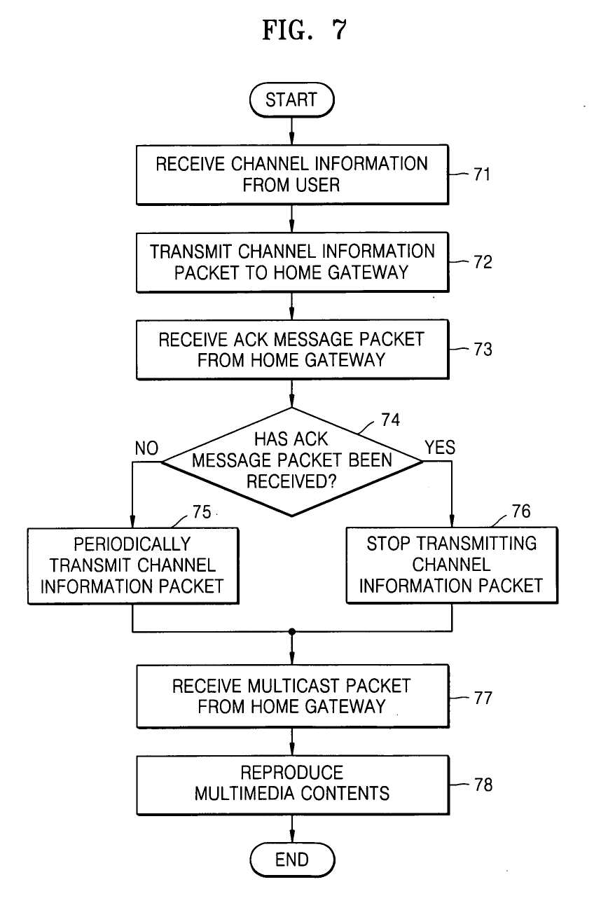

FIG. 7 is a flowchart illustrating a method of reproducing multimedia contents, according to an aspect of the invention. Referring to FIG. 7, in operation 71, channel information concerning a channel selected by a user is received from the user. In operation 72, a channel information packet, which includes a source address field in which an address of a multimedia device is recorded, a destination address field in which an address of a home gateway is recorded, and a channel information field in which the channel information is recorded, is transmitted to the home gateway. In operation 73, an ACK message packet, which includes a source address field in which the address of the home gateway is recorded, a destination address field in which the address of the multimedia device is recoded, and an ACK message for acknowledging the successful receipt of the channel information packet, is received from the home gateway. In operation 74, a determination is made as to whether the ACK message packet has been received. When it is determined that the ACK message packet has not been received, in operation 75, the channel information packet is periodically transmitted until the ACK message packet is received. When it is determined that the ACK message packet has been received, in operation 76, transmitting the channel information packet stops. In operation 77, a multicast packet, which includes a source address field in which the address of the home gateway is recorded, a destination address field in which the address of the multimedia device is recorded, and a multimedia contents field in which multimedia contents provided through a channel indicated by the channel information are recorded, is received from the home gateway. In operation 78, the multimedia contents are reproduced.

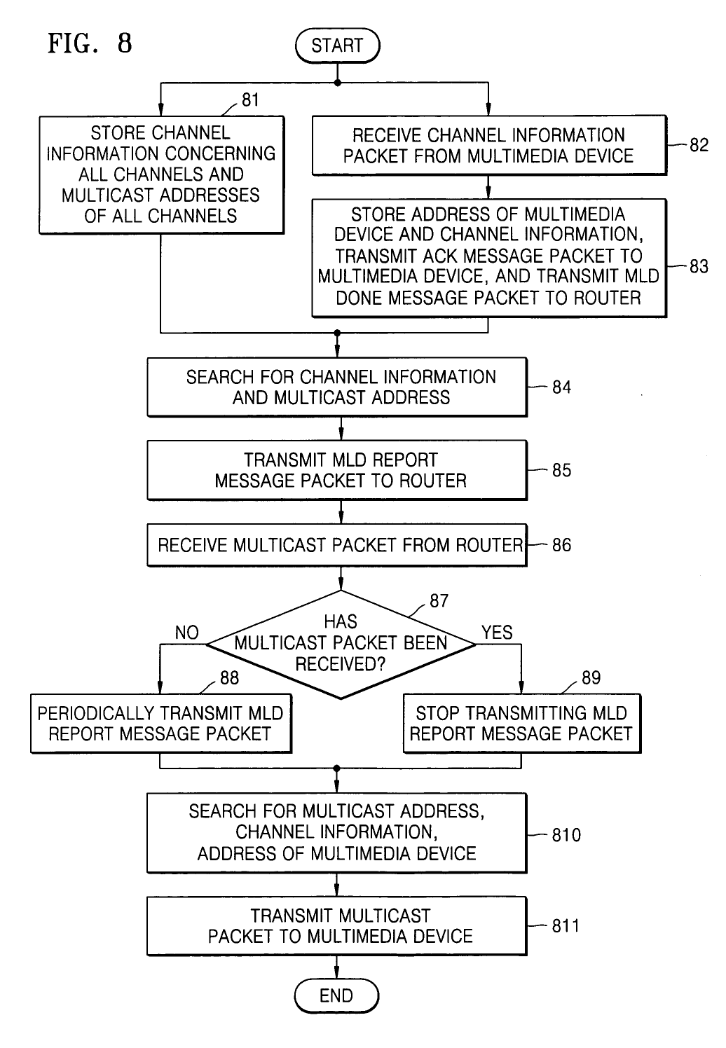

FIG. 8 is a flowchart illustrating a method of relaying a home network according to an aspect of the invention. Referring to FIG. 8, in operation 81, channel information concerning all channels and multicast addresses of all the channels indicated by the channel information are stored so as to correspond to each other, respectively. In operation 82, a channel information packet, which includes a source address field in which an address of a multimedia device is recorded, a destination address field in which an address of a home gateway is recorded, and a channel information field in which channel information concerning a channel selected by a user is recorded, is received from the multimedia device.

In operation 83, the address of the multimedia device in the source address field of the channel information packet and the channel information in the channel information filed of the channel information packet are stored so as to correspond to each other. When the channel information packet is received, an ACK message packet, which includes a source address field in which the address of the home gateway is recorded, a destination address field in which the address of the multimedia device is recorded, and an ACK message for acknowledging the successful receipt of the channel information packet is transmitted to the multimedia device. An MLD done message packet, which includes a source address field in which the address of the home gateway is recorded, a destination address field in which an address of a router is recorded, and an MLD done message for soliciting for stopping transmitting the multicast packet when the channel information packet is received is transmitted to the router.

In operation 84, channel information corresponding to the stored channel information is searched and a multicast address corresponding to the searched channel information is searched. In operation 85, an MLD report message packet, which includes a source address field in which the address of the home gateway is recorded, a destination address field in which the address of the router is recorded, and a multicast address field in which the searched multicast address is recorded, is transmitted to the router.

In operation 86, a multicast packet, that includes a source address field in which the address of the router is recorded, a destination address field in which the address of the home gateway is recorded, a multimedia contents field in which multimedia contents provided through a channel to which the multicast address in the multicast address field of the MLD report message packet is allocated are recorded, and a multicast address field in which the multicast address in the multicast address field of the MLD report message packet is recorded is received from the router.

In operation 87, a determination is made as to whether the multicast packet has been received. When it is determined that the multicast packet has not been received, in operation 88, the MLD report message packet is periodically transmitted until the multicast packet is received. When it is determined the multicast packet has been received, in operation 89, the transmitting the MLD report message packet stops.

In operation 810, a multicast address corresponding to the multicast address in the multicast address field of the multicast packet is searched, channel information corresponding to the searched multicast address is searched, channel information corresponding to the searched channel information is searched, and an address of the multimedia device corresponding to the searched channel information is searched.

In operation 811, a multicast packet, which includes a source address field in which the address of the home gateway is recorded, a destination address field in which the address of the multimedia device is recorded, and a multimedia contents field in which the multimedia contents in the multimedia contents field of the multicast packet are recorded, is transmitted to the multimedia device.

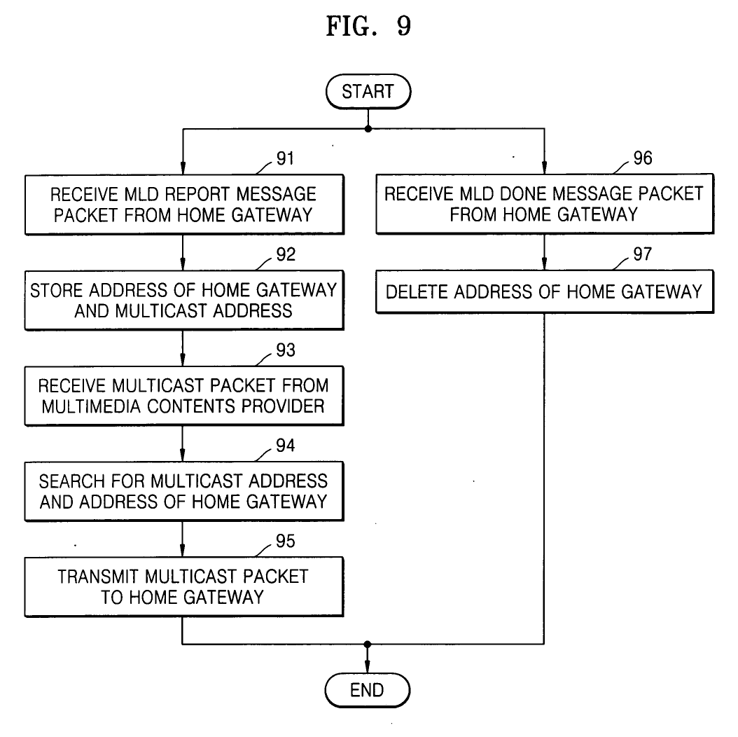

FIG. 9 is a flowchart a method of routing a home gateway according to an aspect of the invention. Referring to FIG. 9, in operation 91, an MLD report message packet, which includes a source address field in which an address of a home gateway is recorded, a destination address field in which an address of a router is recorded, and a multicast address field in which a multicast address of a channel indicated by channel information is recorded, is received from the home gateway. In operation 92, the address of the home gateway in the source address field of the MLD report message and the multicast address in the multicast address field of the MLD report message are stored to correspond to each other.

In operation 93, a multicast packet, which includes a source address field in which an address of a multimedia contents provider is recorded, a destination address field in which the stored multicast address is recorded, and a multimedia contents field in which multimedia contents provided through the channel indicated by the channel information are recorded, is received from the multimedia contents provider which is to provide the multimedia contents. In operation 94, a multicast address corresponding to the multicast address in the destination address field of the received multicast packet is searched and an address of the home gateway corresponding to the searched multicast address is searched.

In operation 95, a multicast packet, which includes a source address field in which the address of the router is recorded, a destination address field in which the address of the home gateway is recorded, a multimedia contents field in which the multimedia contents in the multimedia contents field of the received multicast packet are recorded, and a multicast address field in which the multicast address in the destination address field of the received multicast packet is recorded, is transmitted to the home gateway 2.

In operation 96, an MLD done message packet, which includes a source address field in which the address of the home gateway is recorded, a destination address field in which the address of the router is recorded, and an MLD done message for stopping transmitting the multicast packet when the channel information packet is received, is received from the home gateway. In operation 97, the address of the home gateway in the destination address field of the MLD done message packet is deleted.

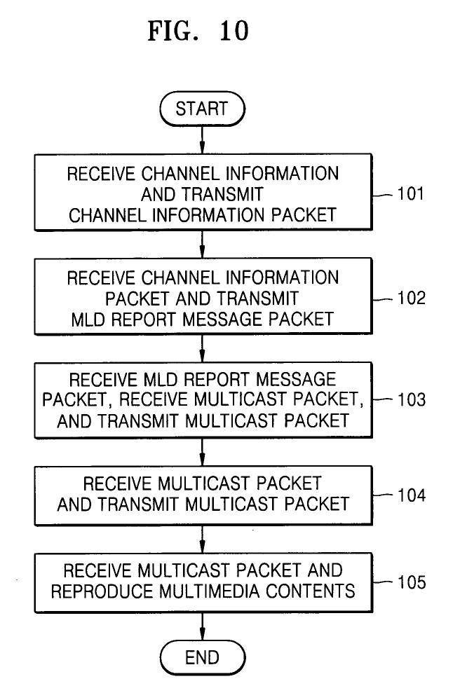

FIG. 10 is a flowchart of a method of multicasting multimedia contents according to an aspect of the invention. Referring to FIG. 10, in operation 101, channel information concerning a channel selected by a user is received from the user and a channel information packet, which includes a source address field in which an address of a multimedia device is recorded, a destination address field in which an address of a home gateway is recorded, and a channel information field in which the channel information is recorded, is transmitted.

In operation 102, the channel information packet is received, and an MLD report message packet, which includes a source address field in which the address of the home gateway is recorded, a destination address field in which an address of a router is recorded, and a multicast address field in which a multicast address of a channel indicated by the channel information in the channel information field of the channel information packet is recorded, is transmitted.

In operation 103, the MLD report message packet is received, a multicast packet, which includes a source address field in which an address of a multimedia contents provider is recorded, a destination address field in which the multicast address in the multicast address field of the MLD report message is recorded, and a multimedia contents field in which multimedia contents provided through the channel indicated by the channel information are recorded, is received from the multimedia contents provider which provides the multimedia contents, and a multicast packet, which includes a source address field in which the address of the router is recorded, a destination address field in which the address of the home gateway is recorded, a multimedia contents field in which the multimedia contents in the multimedia contents field of the received multicast packet are recorded, and a multicast address field in which the multicast address in the destination address field of the received multicast packet is recorded, is transmitted.

In operation 104, the transmitted multicast packet is received, and a multicast packet, which includes a source address field in which the address of the home gateway is recorded, a destination address field in which the address of the multimedia device is recorded, and a multimedia contents field in which the multimedia contents in the multimedia contents field of the received multicast packet are recorded, is transmitted. In operation 105, the transmitted multicast packet is received, and the multimedia contents in the multimedia contents field of the received multicast packet are reproduced.

As described above, in a system for multicasting multimedia contents, a multicast packet, which is transmitted to a router over an access network using a multicasting method, can be transmitted to a multimedia device in a particular location. Thus, the Internet is not congested with a mass amount of data in an IPv6 environment. In particular, as the access network becomes wideband, the multicast packet can be used as an application in an environment in which multimedia contents requiring a wide bandwidth are transmitted via the Internet.

The forgoing aspects of the invention can be written as a computer program and can be implemented by at least one general-use digital computer that executes the program using a computer readable recording medium. Examples of the computer readable recording medium include magnetic storage media (e.g., ROM, floppy disks, hard disks, etc.), optical recording media (e.g., CD-ROMs, or DVDS), and storage media such as carrier waves (e.g., transmission through the Internet).

Although a few embodiments of the present invention have been shown and described, it would be appreciated by those skilled in the art that changes may be made in these embodiments without departing from the principles and spirit of the invention, the scope of which is defined in the claims and their equivalents.

1. A method of reproducing multimedia contents, comprising:
transmitting a first packet including channel information regarding a channel selected by a user;
receiving a second packet including multimedia contents transmitted by multicasting through the selected channel in response to the transmitted first packet; and
reproducing the multimedia contents.

2. The method as claimed in claim 1, further comprising:
receiving the second packet from a home gateway,
wherein the multimedia contents included in the second packet are provided in a multicast packet that is transmitted from a multimedia contents provider by multicasting.

3. The method as claimed in claim 1, further comprising:
receiving a third packet acknowledging a successful receipt of the first packet from a home gateway.

4. The method as claimed in claim 3, further comprising:
periodically transmitting the first packet until the third packet is received.

5. A home network relaying method comprising:
receiving a first packet including channel information regarding a channel selected by a user of a multimedia device;
transmitting a second packet including a multicast address corresponding to the channel information included in the received first packet; and
receiving a third packet including multimedia contents transmitted through the selected channel by using the multicast address in response to the second packet.

6. The home network relaying method as claimed in claim 5, wherein the second packet is a packet for joining the multicast address according to a multicast listener discovery protocol.

7. The home network relaying method as claimed in claim 5, further comprising:
storing channel information and multicast addresses such that each unit of the channel information corresponds with each of the multicast addresses; and
searching for the multicast address corresponding to the channel information from among the stored channel information and multicast addresses.

8. The home network relaying method as claimed in claim 7, comprising:
storing addresses of multimedia devices and channel information such that each of the addresses of the multimedia devices corresponds with each unit of the channel information;
searching for the channel information corresponding to the multicast address included in the third packet from among the stored addresses of multimedia devices and channel information, and searching for an address of the multimedia device corresponding to the searched channel information from among the stored addresses of multimedia devices; and
transmitting a fourth packet including the multimedia contents to a multimedia device that includes the searched address.

9. The home network relaying method as claimed in claim 5, further comprising:
periodically transmitting the second packet until the third packet is received.

10. The home network relaying method as claimed in claim 5, further comprising:
transmitting a packet acknowledging a successful receipt of the first packet to the multimedia device.

11. The home network relaying method as claimed in claim 5, further comprising:
transmitting a packet acknowledging termination of the transmission of the packet when the first packet is received.

12. A home gateway routing method comprising:
receiving a first packet including a multicast address of a channel selected by a user from a home gateway;
receiving a second packet including multimedia contents transmitted through the selected channel by multicasting using the multicast address included in the received first packet as a destination address; and
transmitting a third packet including the multimedia contents included in the received second packet to the home gateway.

13. The home gateway routing method as claimed in claim 12, wherein the first packet is a packet for joining the multicast address according to a multicast listener discovery protocol.

14. The home gateway routing method as claimed in claim 12, further comprising:
storing addresses of home gateways and multicast addresses such that each of the stored addresses of the home gateways corresponds with each of the multicast addresses,
wherein the second packet transmitted by multicasting is received using one of the stored multicast addresses as a destination address.

15. The home gateway routing method as claimed in claim 14, further comprising:
searching for an address of a home gateway corresponding to the multicast address included in the second packet from among the stored addresses of the home gateways and multicast addresses.

16. The home gateway routing method as claimed in claim 14, further comprising:
receiving a fourth packet acknowledging termination of the transmission of a current packet from the home gateway; and
deleting an address of the home gateway that corresponds to the address of the home gateway included in the fourth packet from among the stored addresses of the home gateways and multicast addresses.

17. A computer readable medium having embodied thereon a computer program for a method of reproducing multimedia contents, the method comprising:
transmitting a first packet including channel information regarding a channel selected by a user;
receiving a second packet including multimedia contents transmitted by multicasting through the selected channel in response to the transmitted first packet; and
reproducing the multimedia contents included in the received second packet.

18. A computer readable medium having embodied thereon a computer program for a home network relaying method comprising:
receiving a first packet including channel information regarding a channel selected by a user of a multimedia device;
transmitting a second packet including a multicast address corresponding to the channel information included in the received first packet; and
receiving a third packet including multimedia contents transmitted through the selected channel by using the multicast address in response to the transmitted second packet.

19. A computer readable medium having embodied thereon a computer program for a home gateway routing method comprising:
receiving a first packet including a multicast address of a channel selected by a user from a home gateway;
receiving a second packet including multimedia contents transmitted through the selected channel by multicasting using the multicast address included in the received first packet as a destination address; and
transmitting a third packet including the multimedia contents included in the received second packet to the home gateway.
